(19) United States
(12) Patent Application Publication
(10) Pub. No.: US 2026/0155031 A1
(43) Pub. Date: Jun. 4, 2026

(54) CONTROL METHOD OF ALARMS AND RELATED DEVICES

(71) Applicant: Chudong Liu, Jieyang City (CN)

(72) Inventor: Chudong Liu, Jieyang City (CN)

(21) Appl. No.: 19/036,979

(22) Filed: Jan. 24, 2025

(30) Foreign Application Priority Data
Dec. 1, 2024 (CN) 202422943079.3

(51) Int. Cl. G08B 25/00; G08B 3/10; G08B 17/117; G08B 21/14

(52) U.S. Cl. CPC G08B 25/009; G08B 3/10; G08B 17/117; G08B 21/14

(57) ABSTRACT

This present application provides a control method of alarms and related devices, comprising: obtaining a first information, the first information includes a second information of a first alarm and/or a third information of a second alarm, the second information is used to indicate at least one indicator in a first space, and the third information is used to indicate at least one indicator in a second space; and controlling the first alarm to sound an alert and the second alarm to sound an alert simultaneously according to the first information.

### CROSS REFERENCE TO RELATED APPLICATION

This application claims priority benefit of Chinese patent Application No. 202422943079.3, filed on Dec. 1, 2024, and the entire contents of which are incorporated herein by reference.

### TECHNICAL FIELD

This application relates to electronic technology field, and specifically relates to a control method of alarms and related devices.

### BACKGROUND

To expand the application scope of alarms and further improve their safety, the use of alarms with different functions for warning has become a common means. For example, smoke alarms are mainly used to detect the smoke level. They will immediately sound an alert once smoke is detected. Carbon monoxide alarms are used to detect the level of carbon monoxide. They will also give an alert when the harmful gas is detected. The combination of smoke and carbon monoxide alarms ensures that in case of emergencies such as fires and carbon monoxide leakage, alarms will alert users to take corresponding safety measures on time.

However, when different alarms with different functions are combined for warning, the alarms in different areas or spaces cannot be combined for simultaneous warning. This means that people in different areas cannot be notified on time and are less safe.

### SUMMARY

The present abstract introduces a number of concepts in a simplified form that will be further described below in the detailed description. This abstract is not intended to identify key aspects or essential aspects of the claimed subject matter. In addition, this abstract is not intended to be used as an aid in determining the scope of the claimed subject matter.

In a first aspect, the application provides a control method of alarms, comprising:
obtaining a first information, the first information includes a second information of a first alarm and/or a third information of a second alarm, the second information is used to indicate at least one indicator in a first space, and the third information is used to indicate at least one indicator in a second space; and
controlling the first alarm to sound an alert and the second alarm to sound an alert simultaneously according to the first information.

In a second aspect, the application provides a control system of alarms, comprising:
at least two alarms; and
a controller, which comprises one or more processors and at least one memory storing instructions, that when executed by the one or more processors, cause the controller to:
obtaining a first information, the first information includes a second information of a first alarm and/or a third information of a second alarm, the second information is used to indicate at least one indicator in a first space, and the third information is used to indicate at least one indicator in a second space; and
controlling the first alarm to sound an alert and the second alarm to sound an alert simultaneously according to the first information.

In a third aspect, the application provides a computer-readable storage medium storing instructions that, when executed, cause:
obtaining a first information, the first information includes a second information of a first alarm and/or a third information of a second alarm, the second information is used to indicate at least one indicator in a first space, and the third information is used to indicate at least one indicator in a second space; and
controlling the first alarm to sound an alert and the second alarm to sound an alert simultaneously according to the first information.

The above aspects or examples and advantages, as well as other aspects or examples and advantages, will be apparent from the following description and accompanying drawings.

### BRIEF DESCRIPTION OF THE DRAWINGS

The accompanying drawings are for illustrative purposes only and are not to be construed as limitations of the present patent; and identical reference signs are used for structurally identical and functionally identical members. Among them:

FIG. 1A is a schematic block diagram of a control system of alarms provided in an embodiment of the present application;

FIG. 1B is a schematic block diagram of a controller provided in an embodiment of the present application;

FIG. 2 is a schematic flowchart of a control method of alarms provided in an embodiment of the present application; FIG. 3 is a schematic flowchart of controlling the first alarm to sound an alert and the second alarm to sound an alert simultaneously according to the first information provided in an embodiment of the present application; FIG. 4 is another schematic flowchart of controlling the first alarm to sound an alert and the second alarm to sound an alert simultaneously according to the first information provided in an embodiment of the present application; FIG. 5 is a schematic flowchart of obtaining the first information provided in an embodiment of the present application; FIG. 6 is another schematic flowchart of controlling the first alarm to sound an alert and the second alarm to sound an alert simultaneously according to the first information provided in an embodiment of the present application; FIG. 7 is a schematic configuration diagram of the combined alarm provided in an embodiment of the present application; and

FIG. 8 is a schematic block diagram of a control device of alarms provided in an embodiment of the present application.

### DETAILED DESCRIPTION OF THE EMBODIMENTS

The present disclosure will be further described in detail below with reference to the drawings. A preferred embodiment is described in the drawings. However, the present disclosure can be implemented in many different forms and is not limited to the embodiments described herein. Rather, these embodiments are provided to provide a thorough understanding of the present disclosure. The specific embodiments are only explanations of the present disclosure, and the embodiments are not intended to limit the present disclosure. Rather, various modifications may be made in the details within the scope and range of equivalents of the claims and without departing from the present disclosure.

The present disclosure will be described in more details below with reference to the accompanying drawings and in conjunction with embodiments. The examples are provided for better illustration of the present disclosure and should not limit the scope of the present disclosure. In practice, technicians skilled in the art might make small modifications and/or variations of the present disclosure without departing from the scope or spirit of the present disclosure. For example, features described in part of one embodiment may be used in another to create a new embodiment. It is therefore desirable that the present disclosure encompass such modifications and/or variations falling within the scope of the appended claims and their equivalents.

In the description of the present disclosure, terms like “longitudinal”, “transverse”, “up”, “down”, “front”, “back”, “left”, “right”, “vertical”, “horizontal”, “top”, “bottom” denote orientation or positional relationships based on those shown in the drawings and are intended for ease of description only, which in no way entails that the present disclosure must be constructed and operated in a particular orientation and therefore cannot be construed as limiting to the present disclosure. Terms like “joint”, “attach” and “set” used in the present disclosure should be understood in a broad sense, for example, may indicate a direct connection or indirect connection through intermediate components; and it may be a wired electrical connection, a radio connection, or a wireless communication signal connection. The exact meanings of the above terms may slightly differ and should be derived from the actual situation by technicians skilled in the art accordingly.

Firstly, the control method of alarms provided in embodiments of the present application is mainly applied in a control system to improve a user's security. The control method of alarms provided in embodiments of the present application can be performed by controllers within any of the alarms, controllers in the cloud, or controllers independent of all

### The Alarms.

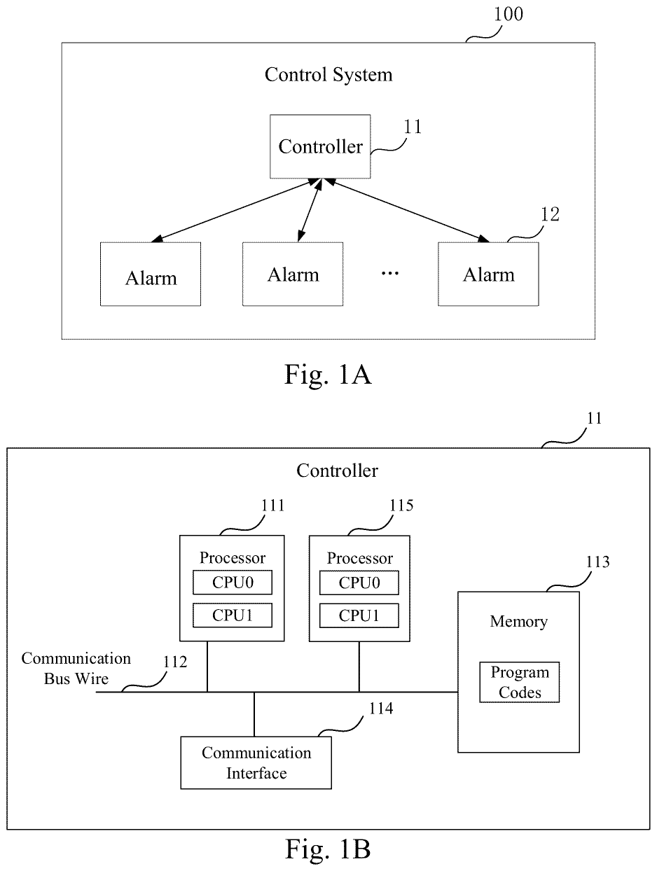

An example of a controller in the cloud is used to describe the use of the embodiments of the present application. Referring to FIG. 1A, FIG. 1A shows a schematic block diagram of a control system of alarms provided in an embodiment of the present application. The control system 100 comprises several alarms 12 and a controller 11.

It is understandable that the alarm 12 can be either an alarm having a single function or an alarm having combined functions, e.g., the alarm 12 has the function of detecting both smoke and carbon monoxide, which is not limited herein.

In practice, the controller 11 is optionally positioned inside any of the alarms 12, which is optionally set according to the actual needs.

The controller 11 is connected to a host computer (not shown in the figures). Wherein, the controller 11 and the host computer can be integrated within the same central processing unit (CPU). The controller 11 is optionally a computing device, such as a server, a desktop computer, a mobile device (e.g., a cell phone, etc.), an in-vehicle device, and the like. It should be understood that the controller 11 is optionally any device in the space that has computing ability and is not limited herein. A writing system and an app are installed in the controller 11. The controller 11 is capable of receiving input/output (I/O) requests from a host computer to control at least one of the alarms 12.

Wherein, the controller 11 can be connected to the alarm 12 using a local connection or a remote connection, including a wired connection and a wireless connection (such as radio frequency (RF), WIFI, Bluetooth, 4G/5G/6G, etc.), and the like.

It is to be noted that FIG. 1A is only an exemplary illustration. The shapes of controller 11 and alarm 12 shown in FIG. 1A, which do not represent the actual physical structures of controller 11 and alarm 12, are not limited herein. In addition, the connection between controller 11 and alarm 12 is only required to ensure that controller 11 can communicate with alarm 12 and is not limited to the embodiments of the present application. In practice, control system 100 optionally comprises two or more controllers, each of which has a similar physical structure and function as the controller 11. The connection between the controllers, as well as between any of the controllers and the alarm, which is not limited in this embodiment, only needs to satisfy that the controllers, as well as the controllers and the alarm, can communicate with each other. In addition, in this embodiment, the controller sends commands to the alarms in a manner that it sends commands to a plurality of alarms at the same time.

Referring to FIG. 1B, FIG. 1B is a schematic block diagram of a controller provided by an embodiment of the present application. As shown in FIG. 1B, controller 11 is practiced via a general bus wire system.

Controller 11 includes at least one processor 111, a communication bus wire 112, a memory 113, and at least one communication interface 114.

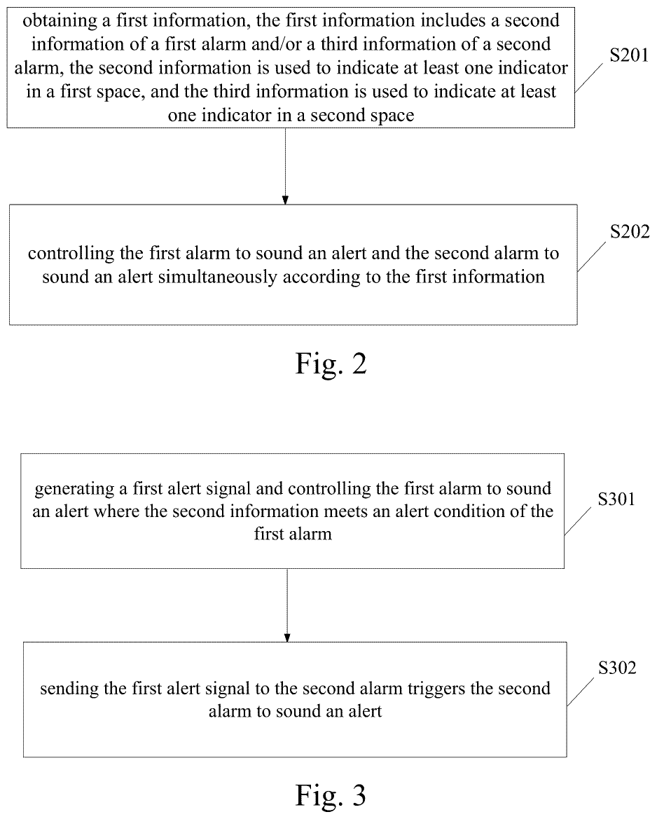

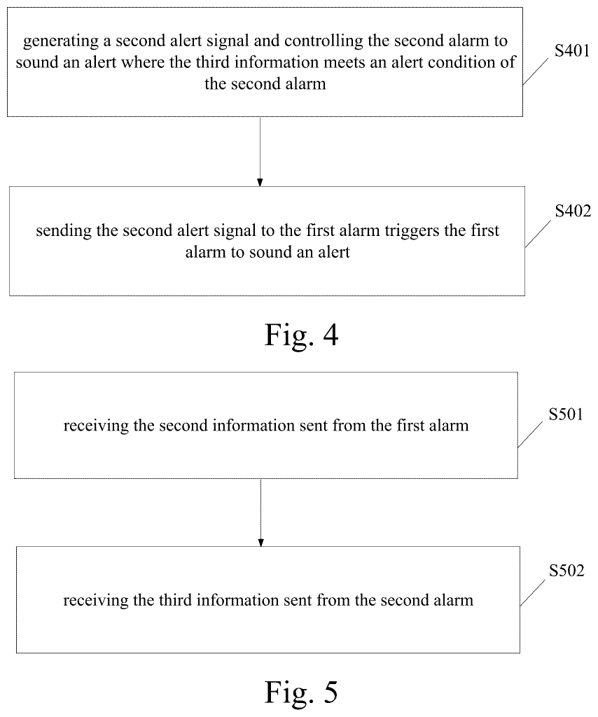

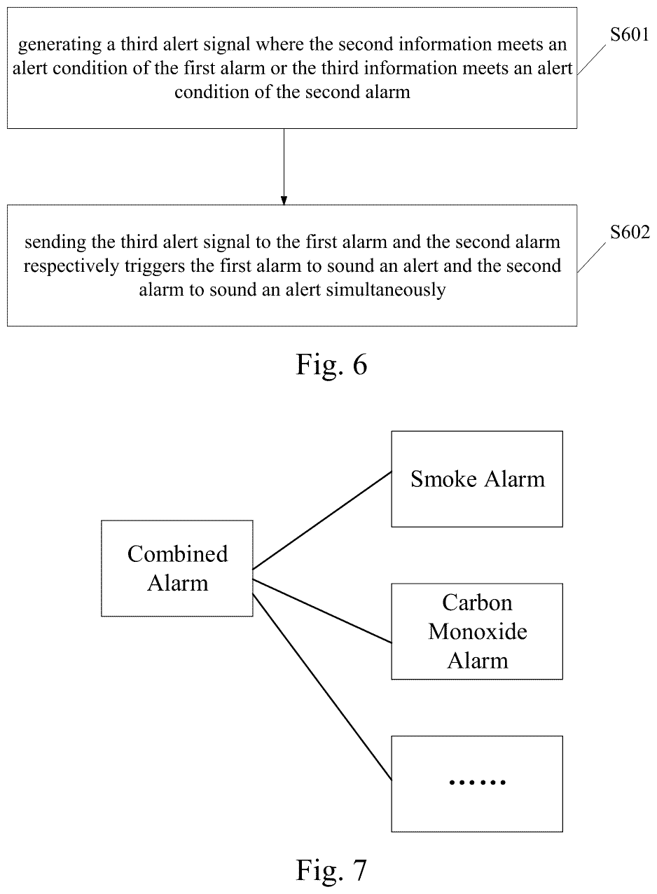

Meanwhile, processor 111, memory 113, and communication interface 114 communicate via the communication bus wire 112 or other means such as wireless transmission. The memory 113 is used to store commands, and the processor 111 is used to perform the commands stored in the memory 113. Memory 113 stores program codes, and processor 111 allows calling of the program codes stored in memory 113 to perform steps S201 to S202 in the embodiment shown in FIG. 2. For details, please refer to the detailed description of steps S201 to S202 in the embodiment shown in FIG. 2, which is not repeated herein.

Optionally, processor 111 is a general-purpose central processing unit (CPU) or other general-purpose processor, such as a digital signal processor (DSP), application-specific integrated circuit (ASIC), field programmable gate array (FPGA), or other programmable logic device (PLD), transistor logic device, hardware component, or any combination thereof. The above PLDs can be complex programmable logic devices (PLDs), transistor logic devices, hardware components, or any combination thereof. The above PLDs are any one or any combination of complex programmable logic devices (CPLDs), field-programmable logic gate arrays (FPGAs), and generic array logic (GALs).

The communication bus wire 112 is used to transfer information between processor 111, memory 113, and communication interface 114. The communication bus wire 112 is one of the address bus wires, data bus wires, control bus wires, etc. For convenience of representation, the control bus is represented in the figure by only one thick line, but it does not mean that there is only one bus wire or one type of bus wire Optionally, memory 113 is one of read-only memory (ROM), static information and instructions storing memory, and other static storage devices. Memory 113 can also be replaced by random access memory (RAM) or other dynamic storage devices capable of storing information and instructions. Memory 113 can also be replaced by electrically erasable programmable read-only memory (EEPROM), compact disc read-only memory (CD-ROM), optical disk storage (including compact discs, laser discs, compact discs, digital versatile discs, Blu-ray discs, etc.), disk storage media or magnetic storage devices, or devices that are capable of carrying or any other medium capable of being used to carry or store desired program code in the form of instructions or data structures and capable of being accessed by a computer, but not limited to it. Optionally, the memory 113 is self-contained and connected to the processor 111 via the communication bus wire 112. Optionally, the memory 113 and the processor 111 are combined.

The communication interface 114 is a transceiver-like device for communicating with other devices or networks. The communication interface 114 includes a wired communication interface. Optionally, the communication interface 114 can also be replaced by a wireless communication interface. Wherein the wired communication interface is, for example, an Ethernet interface. The Ethernet interface is one or a combination of an optical interface and an electrical interface. The wireless communication interface is one or a combination of a wireless local area network (WLAN) interface, a cellular network communication interface, or the like.

In a specific embodiment, as an example, the processor 111 includes multiple CPUs, such as CPU0 and CPU1 shown in FIG. 1B.

In a specific embodiment, as an example, controller 11 includes multiple processors, such as processor 111 and processor 115, as shown in FIG. 1B. Each of these processors is a single-core processor (single-CPU) or a multi-core processor (multi-CPU). Processor herein refers to one or more devices, circuits, or processing cores for processing data, which is, for example, computer program instructions.

In some embodiments, memory 113 is used to store program code for performing the program of the present application, and processor 111 performs the program code stored in memory 113.

The person skilled in the field clearly understands that, for convenience and conciseness of the description, the detailed working process of the above-described devices is described in the corresponding description of the process in the preceding embodiments of the method and will not be repeated herein.

It is understandable that the structure of the control system shown in FIG. 1A and FIG. 1B is only one of the examples, and the control method of the alarm provided by the embodiments of the present application can be, but is not limited to, the structures described above, and is not limited herein.

The control method of alarms provided by embodiments of this application is used in a non-open space, such as the interior of a house, a vehicle, a cabin, and the like. The control method can also be used in a limited space, with alarms with different functions that can be interconnected to alert together. The alarms are connected by wired or wireless connection.

Referring to FIG. 2, FIG. 2 is a schematic flowchart of a control method of alarms provided in an embodiment of the present application. As shown in FIG. 2, the controller can execute steps S201 to S202 to improve safety.

S201, obtaining a first information, the first information includes a second information of a first alarm and/or a third information of a second alarm, the second information is used to indicate at least one indicator in a first space, and the third information is used to indicate at least one indicator in a second space.

Combined alarms are one of the devices combining multiple alarms with a single function or one device with combined functions. Compared to single-function alarms, combined alarms not only detect a variety of indicators in the space but also improve the accuracy and flexibility of detection; in addition, they can save manufacturing costs, installation space, and user convenience.

The embodiments of the present application do not limit the type of alarm, for example, the alarm can be one of a water leakage alarm, a gas alarm (such as gas, natural gas, liquefied petroleum gas, methane, carbon monoxide, and the like) , a power leakage alarm, a smoke alarm, and the like, and the type of alarm is set according to the user's needs in detail, and herein is only for the purpose of illustration.

In one possible embodiment, the first alarm is one of a smoke alarm and a carbon monoxide alarm in detail, and the second alarm is one of a smoke alarm and a carbon monoxide alarm in detail.

By combining the functions of a smoke alarm and a carbon monoxide alarm, the combined alarm ensures a timely alert in the event of a fire emergency, as well as in the event of a carbon monoxide leakage emergency, thus alerting the user to take appropriate safety measures and improving its safety.

The second information is used to indicate at least two indicators in the first space, and the third information is used to indicate at least two indicators in the second space, for example, the second message and the third message both include the two indicators of particles in the smoke and the concentration of carbon monoxide.

In an example, both the first space and the second space are non-open spaces, for example, the first space is one of multiple small spaces divided by architectural factors, geographic factors, or other man-made factors, such as multiple small rooms within a house, multiple rooms within a single floor, multiple floors within a building, and the like.

In a possible embodiment, the first space can be a space within a house, within a vehicle, within a cabin.

The control method of alarms provided by the embodiments of the present application can be performed by a controller within any of the alarms, or by a controller in the cloud, or by a controller independent of all the alarms.

The following describes the execution process in different application cases, respectively.

application case 1: The controller inside each alarm is the execution body of the actions in each step.

In this application case, obtaining the first information from the device such as the sensor inside the alarm by a controller inside the alarm, for example, the first alarm obtains the second information and the second alarm obtains the third information. Then, the controller inside each alarm can determine whether the corresponding trigger condition is met based on the corresponding information of each, respectively, and when any alarm meets the trigger condition to sound an alert, it will notify the other alarms at the same time to make each alarm sound an alert at the same time.

It is understandable that as the time between the first alarm sounding the alert and the other alarms being notified and sounding the alert is so short that it is negligible, the different alarms sounding the alerts can be considered sounding the alerts simultaneously.

application case 2: controller in the cloud or external controller independent of all alarms is the execution body of the actions in each step.

Referring to FIG. 5, in this application case, in a possible embodiment, when the one or more processors further execute the instructions, the controller is configured to obtain the first information by:
S501: receiving the second information sent from the first alarm.
S502: receiving the third information sent from the second alarm.

In order to accomplish the control of each alarm, it is necessary to receive the collected information from each alarm and to determine whether the triggering conditions are met based on the collected information, and if one or multiple information meets the triggering conditions of the corresponding alarms, the alert signal is sent to all the alarms to enable each alarm to sound an alert at the same time.

In one possible embodiment, the individual alarms (for example, the first alarm and the second alarm) communicate with each other through RF signals, WIFI signals, 4G signals, 5G signals, 6G, and so on.

In one possible embodiment, the alarms optionally communicate with each other by using the bidirectional RF FSK communication protocol, optionally in the 868 or 433 frequency bands.

In one possible embodiment, the alarms are interconnected with other alarms through the fire alarm host.

In one possible embodiment, the fire alarm host uses 433 MHz wireless technology and LoRa technology to communicate with other alarms. This enables the alarm to notify users with a faster response time in the event of an emergency that triggers all interconnected alarms to sound an alert at the same time.

In a possible embodiment, the controller, which comprises one or more processors and at least one memory storing instructions, that when executed by the one or more processors, cause the controller to:

S202, controlling the first alarm to sound an alert and the second alarm to sound an alert simultaneously according to the first information.

It is understood that the number of alarms is optionally set according to the actual demand, and the “first” and the “second” referred to above are only to illustrate that the different alarms can be interconnected and send out alerts at the same time, and do not represent the actual number of alarms, or the actual range and number of spaces.

In the process of applying, the same space optionally contains more than one alarm, and where any one of the alarms in the same space sounds an alarm, it can be divided into two situations. In the first situation, when any one of the alarms in the same space sounds an alert, the other compound alarms in the same space and other spaces are triggered at the same time in order to enhance the warning effect. In the second situation, when any one of the alarms in the same space sounds an alert, any one of the compound alarms in the other spaces is triggered to sound an alert at the same time. The specific embodiment method is optionally set according to the actual needs, and the examples shown above are only for the convenience of understanding and are not limited.

The functions of the first alarm and the functions of the second alarm are optionally the same completely, the same partially, or different completely to match the needs of different users, and are not limited.

Referring to FIG. 3, in a possible embodiment, when the one or more processors further execute the instructions, the controller is configured to control the first alarm to sound an alert and the second alarm to sound an alert simultaneously according to the first information by:
S301, generating a first alert signal and controlling the first alarm to sound an alert where the second information meets an alert condition of the first alarm.
S302, sending the first alert signal to the second alarm triggers the second alarm to sound an alert.

This embodiment is suitable for the above-mentioned situation one. In this situation, the controller determines whether the alert condition of the first alarm is met based on the second information, and if the condition is met, the controller generates the first alert signal and sounds an alert. Other alarms in the first space or the second space are associated with the first alarm which is located in the first space, and in order to alert the users in the first space or the second space, the controller sends the first alert signal to the second alarm to alert the users in the second space where the second alarm is located, and thus to help the users in the second space where the second alarm is located to seek help or escape in time and to improve safety.

Referring to FIG. 4, in a possible embodiment, the controller, which comprises one or more processors and at least one memory storing instructions, that when executed by the one or more processors, cause the controller to:
S401, generating a second alert signal and controlling the second alarm to sound an alert where the third information meets an alert condition of the second alarm.
S402, sending the second alert signal to the first alarm triggers the first alarm to sound an alert.

Referring to FIG. 6, in a possible embodiment, when the one or more processors further execute the instructions, the controller is configured to control the first alarm to sound an alert and the second alarm to sound an alert simultaneously according to the first information by:
S601: generating a third alert signal where the second information meets an alert condition of the first alarm or the third information meets an alert condition of the second alarm.
S602: sending the third alert signal to the first alarm and the second alarm respectively triggers the first alarm to sound an alert and the second alarm to sound an alert simultaneously.

This embodiment is suitable for the above-mentioned situation 2. In this situation, the controller generates the third alert signal where the alarm condition of the first alarm is triggered and sends the third alert signal to all the interconnected alarms to enable all the interconnected alarms to sound an alarm at the same time, thus ensuring the timeliness of the alerts and improving the safety.

It should be understood that the first alert signal, the second alert signal, and the third alert signal are optionally the same completely, the same partially, or different completely, which is optionally according to the actual needs, and are not limited.

In a possible embodiment, after the first alarm and the second alarm are controlled to sound an alert by the controller at the same time according to the second information or the third information, the controller sends the alert result to a terminal device, such as a display device, etc., for viewing by the user.

The alert results of any one of the alarms are optionally presented to the users through a display device for easy viewing and timely response. The display device optionally notifies the users of the alert results through a variety of notification methods, such as text messages, phones, application notifications, etc., but the specific forms of the notification methods are not limited.

Optionally, the display device includes a display screen, a cell phone, a computer, and so on.

In a possible embodiment, users check the status of equipment and alert information through the mobile application and PC-monitoring platform.

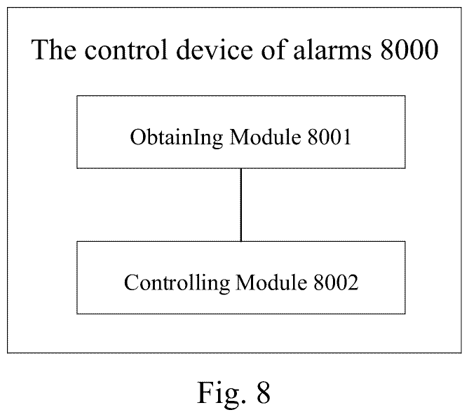

Referring to FIG. 8, FIG. 8 is a schematic block diagram of a control device of alarms provided by an embodiment in the present application.

The control device of alarms 8000 is located in the control system as shown in FIG. 1a. The control device of alarms 8000 includes:

An obtaining module 8001 is used to obtain the first information; the first information includes a second information from a first alarm and/or a third information from a second alarm. The second information is used to indicate at least one kind of indicator in the first space, and the third information is used to indicate at least one kind of indicator in the second space.

A controlling module 8002 is used to control the first alarm and the second alarm to sound an alert at the same time according to the first information.

In a possible embodiment, the controlling module 8002 is also used to:
generate a first alert signal and control the first alarm to sound an alert where the second information meets an alert condition of the first alarm;
send the first alert signal to the second alarm to trigger the second alarm to sound an alarm.

In a possible embodiment, the controlling module 8002, also used to:
Generating a second alert signal and controlling the second alarm to sound an alert where the third information is met by an alert condition of the second alarm;
Sending the second alert signal to the first alarm to trigger the first alarm to sound an alert.

In a possible embodiment, the obtaining module 8001, also used to:

Receiving the second information sent from the first alarm.

In a possible embodiment of the second aspect, the obtaining module 8001, also used to:

Receiving the third information sent from the second alarm.

In a possible embodiment, the controlling module 8002, also used to:
Generating a third alert signal where the second information is met by the alert condition of the first alarm, and/or where the third information is met by the alert condition of the second alarm;
Sending the third alert signal to the first alarm and the second alarm respectively, to trigger the first alarm and the second alarm to sound an alert at the same time.

Referring to FIG. 7, In a possible embodiment, the first alarm includes a smoke alarm and a carbon monoxide alarm, and the second alarm includes the smoke alarm and the carbon monoxide alarm. Wherein the first alarm is a combined alarm, and the second alarm is a combined alarm.

In an embodiment of this application, the operations executed by the units in the control device of alarms 8000 are similar to those described in the method embodiment shown in the preceding FIG. 2 and are optionally used to accomplish the functions of the controllers in the above-described method embodiment, as well as to accomplish the beneficial effects of the above-described method embodiment, which will not be repeated herein. Both the obtaining module 8001 and the controlling module 8002 are optionally accomplished by software or are optionally accomplished by hardware.

The embodiment of this application also provides a computer program product with instructions. The computer program product is optionally a software or program product that contains instructions and can run on the controller or be stored in any available medium. While running on at least one controller, the computer program product enables at least one controller to execute the control method of alarms.

An embodiment of this application also provides a computer-readable storage medium, a computer program stored within the storage medium; the computer program is executed by a processor to accomplish the method of alarms.

The computer-readable storage medium is optionally any available medium that the controller can store or a data storage device, such as a data center containing one or more available media. The available media is optionally a magnetic medium (e.g., floppy disk, hard disk, tape), an optical medium (e.g., DVD), or a semiconductor medium (e.g., a solid-state disk), etc. The computer-readable storage medium includes instructions indicating that the controller will perform the control method of alarms.

It is clear to those technicians in the field belonging to that, for the convenience and brevity of the description, the specific working processes of the above-described systems, devices, and units can refer to the corresponding processes in the preceding embodiments of the method, and will not be repeated herein.

In several embodiments provided in the present application, it should be understood that the systems, devices and methods disclosed, can be practiced in other ways. For example, the device embodiments described above are simply shown schematically, for example, the units are defined only as a logical functional definition, and can be defined in other ways when actually practiced, for example, multiple units or components can be combined or can be integrated into another system. Another point is that the mutual coupling or direct coupling or communication connection shown or discussed may be indirect coupling or communication connection through some interface, device or unit, which may be electrical, mechanical or other forms.

The units illustrated as separated components may or may not be physically separated. The components displayed as units may or may not be physical units, i.e., they can be located in one place or distributed to a plurality of network units. Some or all of these units may be selected to fulfill the purpose of the embodiment scheme according to actual needs.

In addition, the various functional units in various embodiments of this application may be integrated into a single processing unit, or each unit may be physically present separately, or two or more units may be integrated into a single unit. The above-integrated units may be accomplished either in the form of hardware or in the form of software functional units.

The integrated units may be stored in a computer-readable storage medium if implemented as a software functional unit and sold or used as a stand-alone product. Based on this understanding, the technical solution of the present application may be embodied in essence or as a contribution to the prior art, or in whole or in part, in the form of a software product, which is a computer software product stored in a storage medium comprising several instructions to cause a controller (which may be a personal computer, a server, or a network device, etc.) to perform all or some of the steps of the method described in the various embodiments of the present application. The method is described in various embodiments of the present application. The storage medium above includes a USB flash drive, a removable hard disk, a read-only memory (ROM et al.), random access memory (RAM, Random Access Memory), a diskette or a CD-ROM, and other media that can store program code.

This embodiment is suitable for the above-mentioned application case 1. In this case, the controller determines whether the alert condition of the second alarm is met based on the third information. If the condition is met, the controller generates the second alarm signal and sounds an alert. The controller sends the second alert signal to the first alarm to alert the users in the first space or the second space, thus helping the users in the first space where the first alarm is located to seek help or escape in time and to improve safety.

The embodiments described above are merely examples of the present disclosure, and should not be used to limit the scope of the present disclosure, which may have various modifications and variations made by specialists in the field. Any modification, equivalent replacement or improvement made within the spirits and principles of the present disclosure shall be included in the scope of protection of the present disclosure.

What is claimed is:

1. A control method of alarms, comprising:
obtaining a first information, the first information includes a second information of a first alarm and/or a third information of a second alarm, the second information is used to indicate at least one indicator in a first space, and the third information is used to indicate at least one indicator in a second space; and
controlling the first alarm to sound an alert and the second alarm to sound an alert simultaneously according to the first information.

2. The control method according to claim 1, wherein controlling the first alarm to sound an alert and the second alarm to sound an alert simultaneously according to the first information comprises:
generating a first alert signal and controlling the first alarm to sound an alert where the second information meets an alert condition of the first alarm; and
sending the first alert signal to the second alarm triggers the second alarm to sound an alert.

3. The control method according to claim 1, wherein controlling the first alarm to sound an alert and the second alarm to sound an alert simultaneously according to the first information comprises:
generating a second alert signal and controlling the second alarm to sound an alert where the third information meets an alert condition of the second alarm; and
sending the second alert signal to the first alarm triggers the first alarm to sound an alert.

4. The control method according to claim 1, wherein obtaining the first information comprises receiving the second information sent from the first alarm.

5. The control method according to claim 4, wherein obtaining the first information further comprises receiving the third information sent from the second alarm.

6. The control method according to claim 5, wherein controlling the first alarm to sound an alert and the second alarm to sound an alert simultaneously according to the first information comprises:
generating a third alert signal where the second information meets an alert condition of the first alarm or the third information meets an alert condition of the second alarm; and
sending the third alert signal to the first alarm and the second alarm respectively triggers the first alarm to sound an alert and the second alarm to sound an alert simultaneously.

7. The control method according to claim 1, wherein each of the first alarm and the second alarm is one of a smoke detector and a carbon monoxide detector.

8. A control system of alarms, comprising:
at least two alarms; and
a controller, which comprises one or more processors and at least one memory storing instructions, that when executed by the one or more processors, cause the controller to:
obtaining a first information, the first information includes a second information of a first alarm and/or a third information of a second alarm, the second information is used to indicate at least one indicator in a first space, and the third information is used to indicate at least one indicator in a second space; and
controlling the first alarm to sound an alert and the second alarm to sound an alert simultaneously according to the first information.

9. The control system according to claim 8, wherein when the one or more processors further execute the instructions, the controller is configured to control the first alarm to sound an alert and the second alarm to sound an alert simultaneously according to the first information by:
generating a second alert signal and controlling the second alarm to sound an alert where the third information meets an alert condition of the second alarm; and
sending the second alert signal to the first alarm triggers the first alarm to sound an alert.

10. The control system according to claim 8, wherein when the one or more processors further execute the instructions, the controller is configured to control the first alarm to sound an alert and the second alarm to sound an alert simultaneously according to the first information by:
generating a second alert signal and controlling the second alarm to sound an alert where the third information meets an alert condition of the second alarm; and
sending the second alert signal to the first alarm triggers the first alarm to sound an alert.

11. The control system according to claim 8, wherein when the one or more processors further execute the instructions, the controller is configured to obtain the first information by receiving the second information sent from the first alarm.

12. The control system according to claim 11, wherein when the one or more processors further execute the instructions, the controller is configured to obtain the first information by receiving the third information sent from the second alarm.

13. The control system according to claim 12, wherein when the one or more processors further execute the instructions, the controller is configured to control the first alarm to sound an alert and the second alarm to sound an alert simultaneously according to the first information by:
generating a third alert signal where the second information meets an alert condition of the first alarm or the third information meets an alert condition of the second alarm; and
sending the third alert signal to the first alarm and the second alarm respectively triggers the first alarm to sound an alert and the second alarm to sound an alert simultaneously.

14. The control system according to claim 8, wherein each of the first alarm and the second alarm includes a smoke detector and a carbon monoxide detector.

15. A computer-readable storage medium storing instructions that, when executed, cause:
obtaining a first information, the first information includes a second information of a first alarm and/or a third information of a second alarm, the second information is used to indicate at least one indicator in a first space, and the third information is used to indicate at least one indicator in a second space; and
controlling the first alarm to sound an alert and the second alarm to sound an alert simultaneously according to the first information.
